(19) United States
(12) Patent Application Publication
(10) Pub. No.: US 2025/0053500 A1
(43) Pub. Date: Feb. 13, 2025

(54) Specification to Test using Generative Artificial Intelligence

(71) Applicant: NATIONAL INSTRUMENTS CORPORATION, Austin, TX (US)

(72) Inventors: Alejandro Barreto, Austin, TX (US); Andrew Philip Dove, Austin, TX (US); Gregory Clark Richardson, Round Rock, TX (US); Asrar Rangwala, Austin, TX (US); Stephen Thung, Norman, OK (US)

(21) Appl. No.: 18/796,978

(22) Filed: Aug. 7, 2024

Related U.S. Application Data
(60) Provisional application No. 63/518,805, filed on Aug. 10, 2023.

(51) Int. Cl. G06F 11/36

(52) U.S. Cl. CPC G06F 11/3684

(57) ABSTRACT

Apparatuses, systems, and methods for generative Artificial Intelligence (AI) assisted test process development based on an initial input of a specification of a device under test (DUT). The specification of the DUT may be inputted into the Generative AI model. The Generative AI model may summarize the specification, request further input via an interaction with an end user to finalize a description of the DUT, and generate/create test assets, such as code, documentation, tables, diagrams, and so forth. The Generative AI model may collaborate with the end user to refine outputs from the test assets. The refined test assets may be sent to software applications that can use/run/deploy various test assets. Additionally, the generative AI may access local test hardware and enumerate test hardware on other systems via network/serial communications to create a test system that fits the identified hardware.

### PRIORITY DATA

This application claims benefit of priority to U.S. Provisional Application Ser. No. 63/518,805, titled “Specification to Test using Generative Artificial Intelligence”, filed Aug. 10, 2023, which is hereby incorporated by reference in its entirety as though fully and completely set forth herein.

### TECHNICAL FIELD

The invention relates to test process development, and more particularly to apparatuses, systems, and methods for generative Artificial Intelligence (AI) assisted test process development, e.g., using a generative AI based system to produce final test results based on an initial input of a specification of a device under test (DUT).

### DESCRIPTION OF THE RELATED ART

Currently, there are a variety of tools to support a test engineer in test process development when given a specification of a DUT. For example, there are tools to aid a test engineer in the front-end of life cycle of a test process, e.g., such as tools to match tests to instruments. Further, there are tools to aid a test engineer in the back-end of the life cycle of the test process, e.g., such as tools that provide measurement abstraction. In addition, there are various tools that provide high-level test support as well as tools that can generate test sequences based on detailed inputs from the test engineer.

However, a test engineer may need to work/interact with many, disparate software systems to leverage these various tools to develop the test process for the DUT. For example, in various aspects of development of the test process, a test engineer may have the role of a design engineer (e.g., during design of the DUT and/or development of tests that validate the design of the DUT as well as during design of tests than can be reused across the test life cycle of the DUT), test architect (e.g., during design of test systems and identification of reusable components for tests), validation engineer (e.g., during characterization and validation of DUTs), and/or production test engineer (e.g., during development of tests that monitor production processes as well as yield of production DUTs). Each role/tool may require its own expertise and resource, leading to high overhead costs in time, training, and expertise develop. These high overhead costs may then extend time to market for particular products. Therefore, improvements are desirable.

### SUMMARY

Embodiments described herein relate to computing systems, memory media, and methods for generative Artificial Intelligence (AI) assisted test process development, e.g., using a generative AI based system to produce final test results based on an initial input of a specification of a device under test (DUT).

For example, a description and/or specification of a DUT may be inputted (e.g., using various formats such as word processing documents, Portable Document Format (PDF) documents, spreadsheets, presentation documents, three-dimensional (3D) models, two-dimensional (2D) models, images, videos, and/or other multimedia recordings, among other file types and/or formats) into a Generative AI model. The Generative AI model may then summarize the documents and request further input via a question/answer interaction with an end user to finalize a description of the DUT based on the documents. Further, the Generative AI model may query (e.g., via an interactive question/answer session) the end user regarding possible testing options to develop a test process for the DUT. The Generative AI model may then generate/create, e.g., based on the description and/or specification of the DUT and the interactions with the end user, test assets, such as code, documentation, tables, diagrams, and so forth. The Generative AI model may collaborate with the end user to refine outputs from the test assets. The refined test assets may be sent (e.g., deployed, downloaded, transmitted, and so forth), by the generative AI, to software applications that can use/run/deploy various test assets. Additionally, the generative AI may access local test hardware (e.g., various data acquisition cards/systems, signal generation cards/systems, and/or other local systems such as Field Programmable Gate Arrays (FPGAs), real-time controllers, and the like on a local device) and enumerate test hardware on other systems via network/serial communications to create a test system that fits the identified hardware (e.g., both locally and remotely). Once the various tests assets are deployed via the generative AI, the generative AI may receive inputs from the end user to run/conduct testing on the DUT via the various test assets. The generative AI may then receive results from the testing and begin analysis of the results. Finally, the generative AI may offer the end user suggestions on test process refinement (e.g., what to test next and/or how to address failures in the test process), on how to improve the DUT, and/or how to refine specification of the DUT.

In some embodiments, the generative AI may be interacted with via a user interface such as a “chat box” in which documents (e.g., word processing documents, Portable Document Format (PDF) documents, spreadsheets, presentation documents, engineering formatted documents, three-dimensional (3D) models, two-dimensional (2D) models, software models, images, videos, emails, chat transcripts, multimedia recordings, and so forth as well as Virtual Instruments (VIs)) can be directly “dropped” into the chat box for the generative AI to consume. In addition, the generative AI may display, e.g., via the chat box, pinout diagrams, wiring tables/diagrams, VI diagrams, live data tables from tests being performed, and/or other displays of live data from test being performed.

Note that the techniques described herein may be implemented in and/or used with a number of different types of devices, including but not limited to cellular phones, tablet computers, wearable computing devices, portable computing devices, portable media players, and any of various other computing devices.

This Summary is intended to provide a brief overview of some of the subject matter described in this document. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the disclosed embodiments can be obtained when the following detailed description of the preferred embodiments is considered in conjunction with the following drawings.

FIG. 1 illustrates an example of a computer system, according to some embodiments.

FIG. 2 illustrates an example block diagram of a server 104, according to some embodiments.

FIG. 3 illustrates an example of a system supporting a specification to test platform, according to some embodiments.

FIG. 4 illustrates a block diagram of an example of a process for generative AI supported test development, according to some embodiments.

FIG. 5 illustrates a block diagram of an example of a method for artificial intelligence (AI) aided test development, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
AI: Artificial Intelligence
DUT: Device Under Test
UUT: Unit Under Test
VI: Virtual Instrument
GUI: Graphical User Interface

### Terms

The following is a glossary of terms used in this disclosure:

Device Under Test (DUT) or Unit Under Test (UUT)—A physical device or component that is being tested.

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Hardware Configuration Program—a program, e.g., a netlist or bit file, that can be used to program or configure a programmable hardware element.

Graphical Program—A program comprising a plurality of interconnected nodes or icons, where the plurality of interconnected nodes or icons visually indicate functionality of the program. May also be referred to as a Virtual Instrument (VI).

Data Flow Graphical Program (or Data Flow Diagram)—A graphical program or diagram comprising a plurality of interconnected nodes, wherein the connections between the nodes indicate that data produced by one node is used by another node. May also be referred to as a Virtual Instrument (VI).

Graphical User Interface—this term is intended to have the full breadth of its ordinary meaning. The term “graphical user interface” is often abbreviated to “GUI”. A GUI may comprise only one or more input GUI elements, only one or more output GUI elements, or both input and output GUI elements. May also be referred to as a Virtual Instrument (VI).

The following provides examples of various aspects of GUIs. The following examples and discussion are not intended to limit the ordinary meaning of GUI, but rather provide examples of what the term “graphical user interface” encompasses:

A GUI may comprise a single window, panel, or dialog box having one or more GUI Elements, or may comprise a plurality of individual GUI Elements (or individual windows each having one or more GUI Elements), wherein the individual GUI Elements or windows may optionally be tiled together.

Graphical User Interface Element—an element of a graphical user interface, such as for providing input or displaying output. Exemplary graphical user interface elements include input controls and output indicators.

Input Control—a graphical user interface element for providing user input to a program. Exemplary input controls include buttons, check boxes, input text boxes, knobs, sliders, etc.

Output Indicator—a graphical user interface element for displaying output from a program. Exemplary output indicators include charts, graphs, gauges, output text boxes, numeric displays, etc. An output indicator is sometimes referred to as an “output control”.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

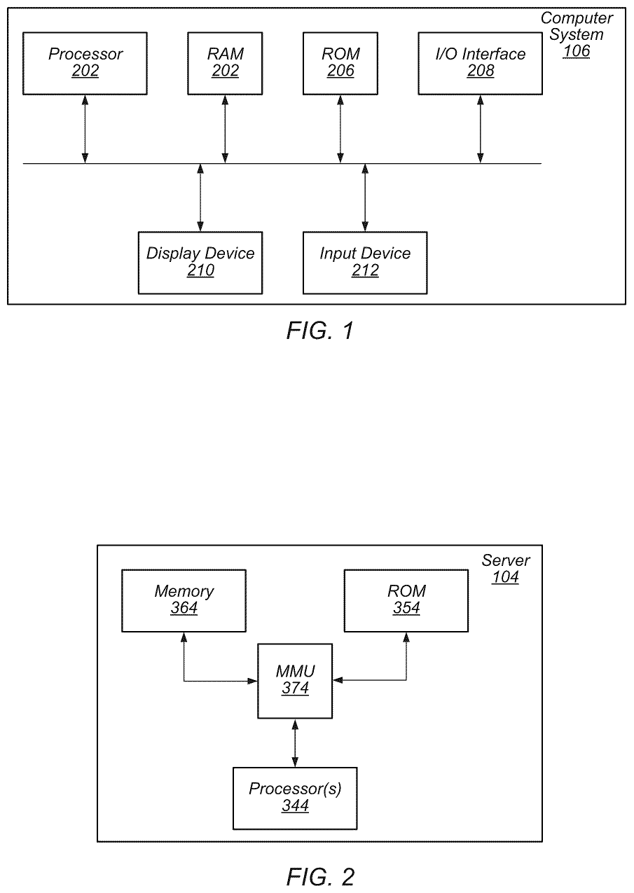

### FIG. 1: Computer System

FIG. 1 illustrates a computer system 106 that may include a processor 202, random access memory (RAM) 204, nonvolatile memory 206, a display device 210, an input device 212 and an I/O interface 208 for coupling to sensors. For example, the computer system 106 may include hardware and software components for implementing or supporting implementation of features described herein. The processor 202 may be configured to implement or support implementation of part or all of the methods described herein, e.g., by executing program instructions stored on a memory medium (e.g., a non-transitory computer-readable memory medium). Alternatively, the processor 202 may be configured as a programmable hardware element, such as an FPGA (Field Programmable Gate Array), or as an ASIC (Application Specific Integrated Circuit), or a combination thereof. Alternatively (or in addition) the processor 202, in conjunction with one or more of the other components 204, 206, 208, 210, and/or 212 may be configured to implement or support implementation of part or all of the features described herein.

In addition, as described herein, processor(s) 202 may be comprised of one or more processing elements. In other words, one or more processing elements may be included in processor(s) 202. Thus, processor(s) 202 may include one or more integrated circuits (ICs) that are configured to perform the functions of processor(s) 202. In addition, each integrated circuit may include circuitry (e.g., first circuitry, second circuitry, etc.) configured to perform the functions of processor(s) 202.

As shown, the computer system 106 may include a processor that is coupled to a random access memory (RAM) and a nonvolatile memory. The computer system 106 may also include user interface elements for receiving user input and a display device for presenting output. For example, the user interface elements may include any of various elements, such as a display (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input. The computer system 106 may also include an Input/Output (I/O) interface that may be communicatively coupled (e.g., locally via a system bus, or remotely via a network and/or serial interface) to various hardware elements (e.g., such as FPGAs, data acquisition boards, controllers, and the like).

### FIG. 2: Server

FIG. 2 illustrates an example block diagram of a server 104, according to some embodiments. It is noted that the server of FIG. 2 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as computer system 106, access to a generative AI, e.g., as further described herein.

In some embodiments, the server 104 may access via a radio access network, such as a 5G New Radio (5G NR) radio access network. In some embodiments, the server 104 may be access via a local area network (LAN), e.g., via an Ethernet and/or Wi-Fi connection.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

### Spec to Test

Currently, a test engineer may need to work/interact with many, disparate software systems to leverage various tools to develop a test process for the DUT. Thus, the current test engineer needs to not only understand the DUT to design the test process, but additionally be versed in a vast array of tools. In various aspects of development of the test process, the test engineer may have the role of a design engineer (e.g., during design of the DUT and/or development of tests that validate the design of the DUT as well as during design of tests than can be reused across the test life cycle of the DUT), test architect (e.g., during design of test systems and identification of reusable components for tests), validation engineer (e.g., during characterization and validation of DUTs), and/or production test engineer (e.g., during development of tests that monitor production processes as well as yield of production DUTs). Each of these roles/tools require independent expertise and resources, leading to high overhead costs in time, training, and expertise develop. These high overhead costs may then extend time to market for particular products. Therefore, improvements are desirable.

Embodiments described herein provide systems, methods, and mechanisms for generative Artificial Intelligence (AI) assisted test process development, e.g., using a generative AI based system to produce final test results based on an initial input of a specification of a device under test (DUT). For example, a description and/or specification of a DUT may be inputted (e.g., using various formats such as word processing documents, Portable Document Format (PDF) documents, spreadsheets, presentation documents, three-dimensional (3D) models, two-dimensional (2D) models, images, videos, and/or other multimedia recordings, as well as programming code, schematics, layouts, designs, bill of materials, and/or other engineer formats) into a Generative AI model executing on a computer system, such as computer system 106, and/or a server, such as server 104. The Generative AI model may summarize (e.g., consume, process, and/or analyze) the documents and request further input via a question/answer interaction with an end user to finalize a description of the DUT based on the documents. Further, the Generative AI model may query (e.g., via an interactive question/answer session) the end user regarding possible testing options to develop a test process for the DUT. For example, the generative AI may query the end user to clarify what the end user meant. In other words, the generative AI may not only provide testing options, but also ask for clarification from the end user on testing options. The Generative AI model may then generate/create, e.g., based on the description and/or specification of the DUT and the interactions with the end user, test assets, such as code, documentation, tables, diagrams, and so forth. The Generative AI model may collaborate with (e.g., interact with and/or guide) the end user to refine outputs from the test assets. The refined test assets may be sent (e.g., deployed, downloaded, transmitted, and so forth), by the generative AI, to software applications that can use/run/deploy various test assets. Additionally, the generative AI may access local test hardware (e.g., various data acquisition cards/systems, signal generation cards/systems, and/or other local systems such as Field Programmable Gate Arrays (FPGAs), real-time controllers, and the like on a local device) and enumerate test hardware on other systems via network/serial communications to create a test system that fits the identified hardware (e.g., both locally and remotely). Once the various tests assets are deployed via the generative AI, the generative AI may receive inputs from the end user to run/conduct testing on the DUT via the various test assets. The generative AI may then receive results from the testing and begin analysis of the results. Finally, the generative AI may offer the end user suggestions on test process refinement (e.g., what to test next and/or how to address failures in the test process), on how to improve the DUT, and/or how to refine specification of the DUT.

In some instances, the Generative AI model may be interacted with via a “chat box” in which documents (e.g., word processing documents, Portable Document Format (PDF) documents, spreadsheets, presentation documents, three-dimensional (3D) models, two-dimensional (2D) models, images, videos, and/or other multimedia recordings as well as Virtual Instruments (Vis)) can be directly “dropped” into the chat box for the Generative AI model to consume. In addition, the Generative AI model may display, e.g., via the chat box, pinout diagrams, wiring tables/diagrams, VI diagrams, live data tables from tests being performed, and/or other displays of live data from test being performed.

In some instances, the Generative AI model may guide a user from specification to test. For example, the Generative AI model may aid and/or develop a test plan based on a DUT specification, a list of required hardware, and channel configurations. In addition, the Generative AI model may generate programming code, e.g., based on LabVIEW™, Python, MeasurementLink, C++, MATLAB™, and so forth. Further, the Generative AI model may generate TestStand™ sequences, operator manuals, calibration codes and/or intervals, and so forth. In this manner, the Generative AI model may support a specification to test (Spec to Test) platform. Additionally, the Generative AI model may produce and/or generate all assets needed to run, deploy, debug, and/or maintained a test system and corresponding tests.

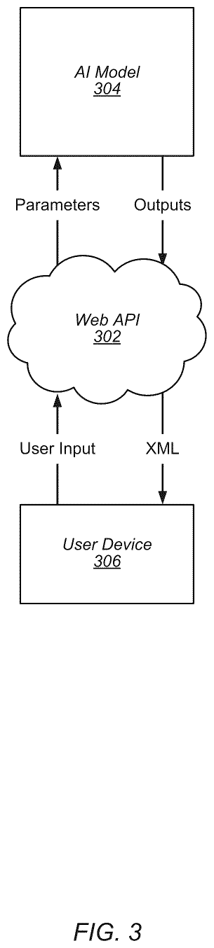

FIG. 3 illustrates an example of a system supporting a specification to test platform, according to some embodiments. As shown, the system may include a user's device 306, e.g., which may be a computer system 106 that provides an interface with a Generative AI model 304 (e.g., which may be hosted on a server, such as server 104) via a web Application Programming Interface (API) 302. The interface may allow the Generative AI model to interact with (e.g., communicate with) local hardware either on the user's device and/or in communication with the user's device. In addition, the interface may allow the Generative AI model to interact with local software resources (e.g., such as programming platforms (e.g., LabVIEW™, Python, MeasurementLink, C++, MATLAB™, and so forth). Thus, as shown, a user may interact with the Generative AI model 304 via web API 302 using the user's device 306. The user's device 306 may execute one or more software resources as well as host hardware (e.g., such as data acquisition boards, control boards, vision boards, and the like) and/or communicate with remote hardware (e.g., such as data acquisition boards, control boards, vision boards, and the like). The user's device 306 may provide user inputs, including information regarding available hardware and/or software resources to the web API 302. The web API 302 may convert the user inputs to AI model parameters and/or the web API 302 may generate AI model parameters based on the user inputs. The AI model parameters may be used by the Generative AI model 304 to generate and/or produce model outputs that are returned to the web API 302. The web API 302 may then convert the model outputs to Extensible Markup Language (XML) and/or generate XML based on the model outputs. For example, the model outputs may include programming code (e.g., such as graphical programming code) that may be converted (e.g., serialized) to Large Language Model (LLM) optimized XML, JavaScript Object Notation (JSON), and/or a Domain Specific Language (DSL). The XML may then be delivered to the user's device 306 as natural language output to an end user. In this manner, the generative AI may interact with the end user to generate test from a specification. Note that the Generative AI model may be trained to query end users using a plurality of prompts based on user input. Further, the Generative AI model may be trained to generate graphical programs based on consuming graphical programs, e.g., the Generative AI model may be trained using thousands of graphical programs. Note further, that aspects of the generative AI may include a user interface executing on the user's device 306 as well as background software to discover and maintain hardware information as well as to discover and maintain connections with local applications, the web API 302 to allow the user's device 306 to interact with the Generative AI model 304, and the Generative AI model 304 that may be executing on a server remote from the user (e.g., the Generative AI model 304 may be cloud based). In addition, the Generative Al model may connect with and/or provide support for technical support associated with the DUT as well as sales/promotional material associated with the DUT. Additionally, the Generative AI model may aid in transitioning from validation to production (e.g., generating test code, such as TestStand sequences from graphical code, such as LabVIEW Virtual Instruments), from production to validation (e.g., generating debugging and tracing code for graphical code, such as LabVIEW Virtual Instruments), and from design to validation (e.g., generating test code from a virtual model of a DUT, e.g., such as TestStand sequences based on the virtual model).

As noted above, in some instances, the Generative AI model may generate and/or produce programming code. The programming code may include graphical programming code, graphical instruments, test sequences. In addition, the Generative AI model may generate and/or produce test plans and/or DUT specifications. Further, the Generative AI model may optimize existing programming code, detect software weaknesses, and/or software vulnerabilities. Additionally, the Generative AI model may generate APIs for sensors from sensor specification as well as adopt existing programming code to new scenarios.

In addition, as noted above, in some instances, the Generative AI model may generate and/or produce documents such as test system configurations, assembly procedures, operational procedures, and/or calibration procedures. These documents may be based and/or adapted from existing documents. Additionally, the Generative AI model may summarize long documents to ease end user consumption and/or generate coverage certification documents.

Further, as noted above, in some instances, the Generative AI model may aid in test development. For example, the Generative AI model may identify “corner cases” (e.g., edge of envelop testing conditions). As another example, the Generative AI model may identify test failure modes and/or determine cause of a test failure. As a further example, the Generative AI model may identify improvements related to test time, test resources, test reliability, test structure, and so forth.

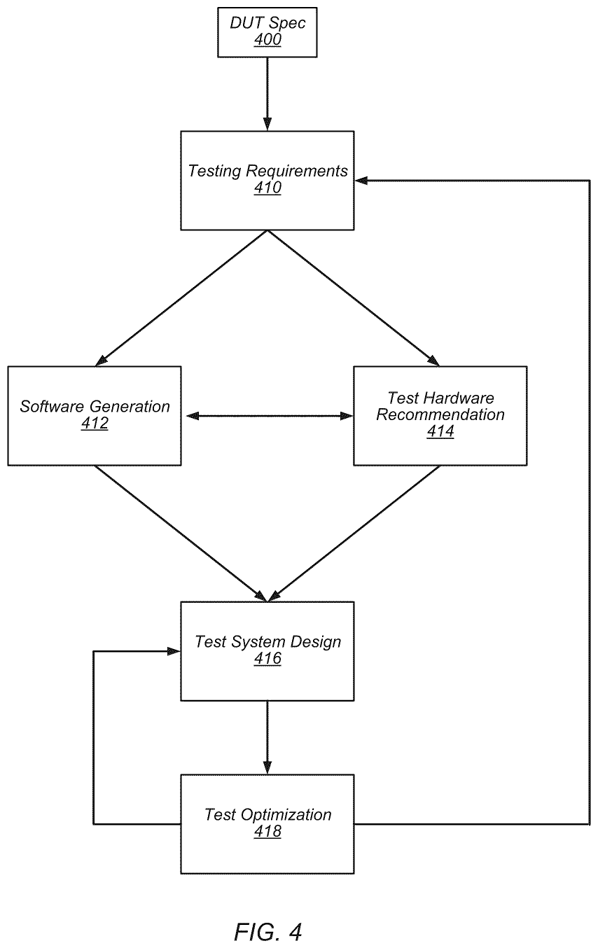

FIG. 4 illustrates a block diagram of an example of a process for generative AI supported test development, according to some embodiments. The process shown in FIG. 4 may be used in conjunction with any of the systems, methods, or devices shown in the Figures, among other devices. In various embodiments, some of the process elements shown may be performed concurrently, in a different order than shown, or may be omitted. Additional process elements may also be performed as desired. As shown, this process may operate as follows.

At 400, a DUT specification may serve as input to the process. The DUT specification may take one of many forms. For example, the DUT specification may include any, any combination of, and/or all of a database including information specifying the DUT, a computer generated (e.g., virtual) model (e.g., including both 2D and/or 3D models as well as software models) of the DUT specifying information associated with the DUT, PDF-based documentation, spreadsheet-based documentation, word based documentation, images (e.g., single images and/or streams of images), PIN-out diagrams, performance data, programming code (e.g., such as C/C++, C#, Python, Ruby, Rust, BASIC, FORTRAN, VHDL, and/or Verilog code, among other programming codes), schematics, layouts, designs, bill of materials (BOM), emails, chats, audio recordings, video recordings, engineering formats (e.g., comma-separated values (CVS) files, Extensible Markup Language (XML) files, JavaScript Object Notation (JSON) files, MATLAB Data File format (MAT) files, Technical Data Management Streaming (TDMS) files, Hierarchical Data Format version 5 (HDF5) files, a drawing format (DWG) files, a 3D printing format (STL) file, Standard for the Exchange of Product (STEP) model data file, Initial Graphics Exchange Specification (IGES) file, a G-code (a numerical control (NC) programming language used for CNC machining) file, a Printed Circuit Board (PCF) file format such as Gerber (RS-274X) and/or ODB++, a SIMULINK Model file, an ASCII STL format file, a Building Information Modeling (BIM) file, such as Industry Foundation Classes (IFC) for interoperability in construction projects, a Standard Test Data Format (STDF) file, an Automatic Test Description Format (ATDF) file, a Boundary Scan Description Language (BSDL) file, a VHDL/Verilog file (e.g., hardware description languages often used for writing test benches and simulation models for semiconductor devices), a Waveform Generation Language (WGL) file (e.g., utilized for specifying digital test patterns to test vector-based semiconductor devices, a Test Description Language (TDL) file, a Graphic Data System II (GDSII) file, a Test Access Port (TAP) file (e.g., a standard for accessing embedded test and debug features of semiconductor devices), and/or a DAT file (e.g., a generic format used to store various types of test data, such as waveform or parametric test results, among other types of engineering formats), and/or other forms of documentation. Thus, the input of the DUT specification to the process may take the form of word processing documents, PDF documents, spreadsheets, presentation documents, 3D models, 2D models, images, videos, and/or other multimedia recordings.

At 410, the Generative AI model may consume (e.g., process and/or analyze) the DUT specification, e.g., to generate machine-readable hardware requirements and/or machine-readable software requirements. In other words, the Generative AI model may generate/develop/design machine-readable hardware requirements and/or readable software requirements based on consumption (e.g., processing and/or analyzing) the DUT specification. In some instances, the Generative AI model may summarize (e.g., consume, process, and/or analyze) the documents for an end user (e.g., and display the summary via a user interface, such as a “chat box”) and request further input via a question/answer interaction (e.g., via the user interface) with the end user to finalize the description of the DUT based on the inputted DUT specification. Further, the Generative AI model may query (e.g., via an interactive question/answer session) the end user regarding possible testing options to develop the machine-readable hardware requirements and/or machine-readable software requirements.

At 412, the Generative AI model may use the machine-readable software requirements to generate test software (e.g., a test asset), e.g., software to implement and/or conduct testing on the DUT as well as output test results and/or test data. The test software may be realized in one or more of multiple programming languages including, but not limited to, graphical-based programming languages, sequence-based programming languages, and/or code-based programming languages. For example, the Generative AI model may generate test software based on LabVIEW™, Python, MeasurementLink, C++, MATLAB™, and so forth, as well as, generate TestStand™ sequences, operator manuals, calibration codes and/or intervals, and so forth. Note that, as shown, the generation of test software may be dependent upon the test hardware component recommendations and/or configurations generated at 414.

At 414, the Generative AI model may use the machine-readable hardware requirements to generate test hardware component recommendations and/or configurations (e.g., test assets). Thus, the Generative AI model may discover available local hardware components (e.g., various data acquisition cards/systems, signal generation cards/systems, and/or other local systems such as FPGAs, real-time controllers, and the like on a local device and enumerate test hardware on other systems via network/serial communications to create a test system that fits the identified hardware (e.g., both locally and remotely))) as well as recommend hardware components. Note that, as shown, the generation of test hardware component recommendations and/or configurations may be dependent upon the test software generated at 412. In some instances, e.g., such as when an end user does not have and/or can not obtain the recommend hardware components, the Generative AI model may collaborate with the end user to suggest, recommend, and/or develop a test system based on available and/or attainable hardware components.

At 416, the Generative AI model may use the test software generated at 412 and/or the test hardware component recommendations and/or configurations generated at 414 to generate a test system design. Thus, the Generative AI model may provide a test system design based on the DUT specification (e.g., specification to test). Further, the Generative AI model may output test results.

At 418, the Generative AI model may further aid in test fleet optimization, e.g., aid in the development of the designed test system into a fleet of test systems. For example, as data is collected and fed back into the Generative AI model, the Generative AI model may suggest test improvements via test software optimization, test parameter optimization, test hardware optimization, and so forth, which may then serve as input to the test system design at 416. Further, the Generative AI model may optimize testing based on fleet test results to evolve and/or optimize test requirements, which may then serve as input to the Generative AI model at 410.

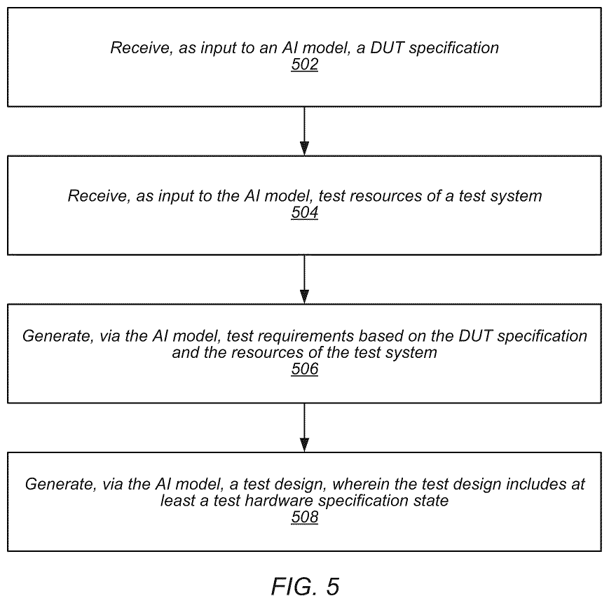

FIG. 5 illustrates a block diagram of an example of a method for artificial intelligence (AI) aided test development, according to some embodiments. The method shown in FIG. 5 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 502, a device under test (DUT) specification may be received as input to an AI model, such as AI model 304. The DUT specification may be received via a user interface. The user interface may be chat box based. Further, the DUT specification may include at least one of (e.g., one or more of, a plurality of, and/or all of) a database including information specifying the DUT, a virtual two-dimensional model of the DUT, a virtual three-dimensional model of the DUT, a software model of the DUT, a portable document format (PDF)-based document, a spreadsheet-based document, a word processor-based document, a presentation-based document, one or more images of the DUT, one or more videos of the DUT, a diagram of the DUT, performance data associated with the DUT, programming code, an engineering format-based file or document, a schematic of the DUT, a schematic associated with the DUT, a layout of the DUT, a layout associated with the DUT, a design of the DUT, a design associated with the DUT, a bill of materials (BOM) associated with the DUT, emails associated with and/or referring to the DUT and/or an aspect of the DUT, a chat transcript associated with and/or referring to the DUT and/or an aspect of the DUT, an audio recording associated with and/or referring to the DUT and/or an aspect of the DUT, and/or a video recording associated with and/or referring to the DUT and/or an aspect of the DUT.

In some instances, the DUT specification may be summarized and the summarization of the DUT may be presented to an end user. Further, the end user may be queried (e.g., questioned) regarding the DUT specification, e.g., to clarify the summarization. The querying may include presenting leading questions to the end user. The leading questions may be provided by the AI model. In some instances, the AI model may be a large language model (LLM), e.g., a Generative AI model.

At 504, test resources of a test system may be received as input to the AI model. In some instances, the test resources may include machine-readable hardware requirements. The machine-readable hardware requirements may be received via local discovery. The machine-readable hardware requirements may indicate available local system hardware components. The local system hardware components may include one or more local hardware resources reachable via a local system bus. The one or more local hardware resources may include one or more of (e.g., at least one of, a plurality of, and/or all of) a peripheral component interconnect (PCI)/enhanced PCI (ePCI) data acquisition card, a PCI/ePCI signal generator, a PCI/ePCI Field Programable Gate Array (FPGA), a PCI/ePCI controller, a PCI/ePCI vision card, a Universal Serial Bus (USB) device, a General Purpose Interface Bus (GPIB) device, and/or a serial device. Further, the local system hardware components may include one or more remote hardware resources reachable via a local network connection or a local serial connection. The one or more remote hardware resources may include one or more of (e.g., at least one of, a plurality of, and/or all of) a PCI/ePCI data acquisition card, a PCI/ePCI signal generator, a PCI/ePCI FPGA, a PCI/ePCI controller, a PCI/ePCI vision card, a USB device (e.g., controller, data acquisition card, vision card, signal generator, and so forth), a GPIB device (e.g., controller, data acquisition card, vision card, signal generator, and so forth), and/or a serial device (e.g., controller, data acquisition card, vision card, signal generator, and so forth).

At 506, test requirements based on the DUT specification and the resources of the test system may be generated via the AI model.

At 508, a test design may be generated, via the AI model. The test design may include at least a test hardware specification. Further, the test design may further include at least a software program. The software program may be executable to perform the test design. Additionally, the software program may include a graphical user interface. In addition, the software program may be generated based on a graphical programming platform and/or graphical programming language. In some instances, the software program may be generated based on a sequence based graphical programming platform/language, a code-based programming platform/language. In some instances, the software program may be generated based on software programs used to train the AI model. In some instances, the test design may also include at least one of (e.g., one or more of, a plurality of, and/or all of) a test calibration sequence, test process documentation, a user manual associated with the test process, and/or a graphical user interface to display test results.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a computer system 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for artificial intelligence (AI) aided test development, comprising:
receiving, as input to an AI model, a device under test (DUT) specification for a DUT;
receiving, as input to the AI model, test resources of a test system;
generating, via the AI model, test requirements based on the DUT specification and the test resources of the test system; and
generating, via the AI model, a test design, wherein the test design includes at least a test hardware specification.

2. The method of claim 1,
wherein the test design further includes at least a software program.

3. The method of claim 2,
wherein the software program is executable to perform the test design.

4. The method of claim 2,
wherein the software program includes a graphical user interface.

5. The method of claim 2,
wherein the software program is generated based on a graphical programming platform, a graphical programming language, or a sequence based graphical programming platform.

6. The method of claim 2,
wherein the software program is generated based on a code-based programming platform or code-based programming language.

7. The method of claim 2,
wherein the software program is generated based on software programs used to train the AI model.

8. An apparatus, comprising:
a memory;
a network interface; and
at least one processor in communication with the memory and network interface, wherein the at least one processor is configured to execute a Generative Artificial Intelligence (AI) model, wherein the Generative AI model is trained via machine learning to:
receive, as input, a device under test (DUT) specification for a DUT and test resources of a test system;
generate test requirements based on the DUT specification and the test resources of the test system; and
generate a test design, wherein the test design includes at least a test hardware specification.

9. The apparatus of claim 8,
wherein to receive, as input, test resources of the test system, the Generative AI model is further trained via machine learning to receive, via local discovery, machine-readable hardware requirements.

10. The apparatus of claim 9,
wherein the machine-readable hardware requirements indicate available local system hardware components.

11. The apparatus of claim 10,
wherein the available local system hardware components include one or more local hardware resources reachable via a local system bus; and
wherein the one or more local hardware resources include one or more of:
a peripheral component interconnect (PCI)/enhanced PCI (ePCI) data acquisition card;
a PCI/ePCI signal generator;
a PCI/ePCI Field Programable Gate Array (FPGA);
a PCI/ePCI controller;
a PCI/ePCI vision card;
a Universal Serial Bus (USB) device;
a General Purpose Interface Bus (GPIB) device; or
a serial device.

12. The apparatus of claim 10,
wherein the available local system hardware components include one or more remote hardware resources reachable via a local network connection or a local serial connection; and
wherein the one or more remote hardware resources include one or more of:
a peripheral component interconnect (PCI)/enhanced PCI (ePCI) data acquisition card;
a PCI/ePCI signal generator;
a PCI/ePCI Field Programable Gate Array (FPGA);
a PCI/ePCI controller;
a PCI/ePCI vision card;
a Universal Serial Bus (USB) device;
a General Purpose Interface Bus (GPIB) device; or
a serial device.

13. The apparatus of claim 8,
wherein the DUT specification is received via a user interface comprising a chat box based.

14. The apparatus of claim 8,
wherein the DUT specification comprises at least one of:
a database including information specifying the DUT;
a virtual two-dimensional model of the DUT;
a virtual three-dimensional model of the DUT;
a software model of the DUT;
a portable document format (PDF)-based document;
a spreadsheet-based document;
a word processor-based document;
a presentation-based document;
one or more images of the DUT;
one or more videos of the DUT;
a diagram of the DUT;
performance data associated with the DUT;
programming code;
an engineering format-based file or document;
a schematic of the DUT;
a schematic associated with the DUT;
a layout of the DUT;
a layout associated with the DUT;
a design of the DUT;
a design associated with the DUT;
a bill of materials (BOM) associated with the DUT;
emails associated with and/or referring to the DUT and/or an aspect of the DUT;
a chat transcript associated with and/or referring to the DUT and/or an aspect of the DUT;
an audio recording associated with and/or referring to the DUT and/or an aspect of the DUT; or
a video recording associated with and/or referring to the DUT and/or an aspect of the DUT.

15. The apparatus of claim 8,
wherein the Generative AI model is further trained via machine learning to:
summarize the DUT specification; and
present the summarization of the DUT to an end user.

16. The apparatus of claim 15,
wherein the Generative AI model is further trained via machine learning to:
query the end user regarding the DUT specification, including presenting leading questions to the end user.

17. A computer system, comprising:
a memory;
at least one network interface;
at least one display; and
at least one processor in communication with the memory, the at least one network interface, and the at least one display and configured to:
receive, as input to a large language model (LLM), a device under test (DUT) specification for a DUT and test resources of a test system;
generate, via the LLM, test requirements based on the DUT specification and the test resources of the test system; and
generate, via the LLM, a test design, wherein the test design includes at least a test hardware specification.

18. The computer system of claim 17,
wherein the test design further includes at least one of:
a test calibration sequence;
test process documentation;
a user manual associated with a test process; or
a graphical user interface to display test results.

19. The computer system of claim 17,
wherein the test design further includes at least a software program executable to perform the test design, and wherein the software program includes a graphical user interface.

20. The computer system of claim 17,
wherein, to receive, as input to the LLM, test resources of the test system, the at least one processor is further configured to receive, via local discovery, machine-readable hardware requirements, wherein the machine-readable hardware requirements indicate available local system hardware components, and wherein the available local system hardware components include one or more local hardware resources reachable via a local system bus and one or more remote hardware resources reachable via a local network connection or a local serial connection.
